(19) United States
(12) Patent Application Publication
(10) Pub. No.: US 2013/0122174 A1
(43) Pub. Date: May 16, 2013

(54) MANUFACTURE OF COOKIES HAVING REDUCED LIPID CONTENT

(71) Applicants: Van Miller, Norval (CA); Michael Robert Knapp, Willowdale (CA)

(72) Inventors: Van Miller, Norval (CA); Michael Robert Knapp, Willowdale (CA)

(21) Appl. No.: 13/471,787

(22) Filed: May 15, 2012

(30) Foreign Application Priority Data
Nov. 10, 2011 (CA) 2757881

(51) Int. Cl. A21D 2/32; A21D 2/38; A21D 2/34

(52) U.S. Cl. 426/558; 426/549

(57) ABSTRACT

Flour-based cookies having any standard commercial cookie formulation which includes at least the presence of flour, sugar, and fat, as well as any other cookie ingredients as required, are prepared so that the fat constituent of the commercial cookie formulation comprises a cookie-compatible lipid which has been combined with 0.2% to 7.0% of an organically derived phospholipid, based on the weight of fat solids of the cookie-compatible lipid. The fat constituent is thoroughly mixed with the sugar constituent of said commercial cookie formulation prior to the mixture of the fat constituent and the sugar constituent being added to all other cookie ingredients of the specific commercial cookie formulation.

### FIELD OF THE INVENTION

This invention relates to cookies, and in particular relates to the production of commercial cookies having reduced lipid content. By that, it is therefore meant that the commercially produced cookies may be brought to the market with a lower fat content, and advertised as such. This invention, in particular, provides for the manufacture of flour-based cookies which may have any standard commercial cookie formulation, provided that the commercial cookie formulation includes at least flour, sugar, and a fat constituent. Of course, many other cookie ingredients may also be used, so that the present invention has quite wide ramifications to the cookie industry. Specifically, the present invention provides a means whereby the lipid content of commercially baked cookies may be reduced and yet the organoleptic properties of the commercial cookies will remain substantially the same or may even be improved. To that end, the present invention provides that commercially baked cookies in keeping with the invention shall include about 0.2% to 7.0% by weight of the fat constituent, of an organically derived phospholipid which has been combined with the fat constituent, and that the fat constituent be thoroughly mixed with the sugar constituent prior to any other cookie ingredients being added to the dough that is being made. Preferably, commercially baked cookies in keeping with the invention should include about 0.4% to 2.5% by weight of the fat constituent, of an organically derived phospholipid which has been combined with the fat constituent.

### BACKGROUND OF THE INVENTION

The commercial cookie industry is a very large industry throughout the entire developed world. Packaged, commercially baked cookies are available throughout North and South America, Europe, Asia, Australia, and at least the developed countries of Africa. Typically, such commercially baked cookies are flour-based, and it is those cookies to which the present invention is directed. Thus, very dry baked products such as soda crackers or rice crackers are not contemplated as being suitable for the present invention. On the other hand, the present invention does contemplate many different kinds of commercially baked cookies, including without limitation, oatmeal cookies, ginger snaps, sandwich cookies of all sorts, other rotary moulded cookies of all sorts, shortbreads, cookies made with raisins and other fruits and pieces of fruits and fruit peel, cookies made with discrete chocolate or butterscotch chips or pieces or chunks, and so on as are well known to those skilled in the commercial cookie art.

However, in most parts of the world, greater consideration is now being given to the possible contribution that commercially baked cookies have had with respect to growing levels of obesity, especially child obesity. As is well understood, children like cookies and it is hard to discipline them or their parents or guardians to disregard the opportunity to eat a cookie, except in special circumstances such as diabetes or gluten intolerance. A major approach to providing commercially baked cookies that have lower calorie content has been simply to reduce the fat content and/or the sugar content in the otherwise standard commercial cookie formulation, but this has not resulted in acceptable commercially baked cookie products. In particular, when the fat content has been reduced in the recipe, the baked cookie product which results may be drier or more crumbly or have otherwise unacceptable organoleptic property; and it may also have shorter shelf life. This is particularly true in cases where the fat content of the commercially baked cookies comprises fats such as butter, shortening, and mixtures thereof, together with other cookie compatible oils.

It is well known that the fat constituent of any dough system, particularly with respect to commercially baked cookies, acts to lubricate the dough system so as to extend the shelf life of the commercially baked cookies, as well as to improve the texture of the cookies. Shelf life of commercially baked cookies is primarily extended, in such instances, by efforts to lubricate and spread the fats and oils of the fat content throughout the dough system in such a manner as to coat the sugar constituents of the dough system, thereby precluding the ingress of air to the sugar constituents. However, when the fat content is reduced, so too is the ability of the remaining fat constituent which has been included in the recipe or formulation for the commercially baked cookies to spread and coat the sugar.

The inventors herein have unexpectedly discovered that much superior lubrication and improved shelf life of commercially baked cookies may be achieved by the addition of an organically derived phospholipid to the cookie compatible lipid which comprises the fat constituent of the commercially baked cookies. Moreover, the inventors herein have further discovered that the addition of a cookie compatible lipid/phospholipid mixture to the sugar constituent of the commercially baked cookie formulation, before any other cookie compatible ingredients are added, results in the production of highly acceptable commercially baked cookies having fully acceptable organoleptic properties and acceptable shelf life.

All of this is achieved because the addition of an organically derived phospholipid to the cookie compatible fat system results in a higher lubrication facility within the dough system, and a more complete coating of the sugar constituent of the commercially baked cookie formulation. This is so because the organically derived phospholipid acts not only as an emulsifier, but also as a surfactant within the dough system. Particularly, its functionality is most evident and important when the fat constituent and the organically derived phospholipid are mixed together prior to their introduction to the sugar constituent, and wherein that mixture is thereafter introduced into the dough system together with whatever other cookie compatible ingredients are being used in the specific commercially baked cookie formulation or recipe.

It must be emphasized at this point that many chemically derived emulsifiers are well known, such as monodiglycerides and the like. However, such chemically derived emulsifiers have no capability to function as a surfactant.

It must also be noted that when calculations of fat constituent by weight are made in keeping with the present invention, it is the fat solids that are considered. In other words, typical constituents of some commercially baked cookies, such as shortbread, include butter as their fat constituent, or at least a portion thereof. However, it is recognized that, for the most part, butter typically comprises about 18% to 20% water; and it is the remaining 80% to 82% of the weight of the butter which is considered in making the calculation with respect particularly to the addition of the organically derived phospholipid, which is done on a “by weight” or “per unit weight” basis.

Thus, in keeping with the present invention, it is possible to reduce the fat constituent in the formulation of commercially baked cookies so as to prepare the commercially baked cookie having a reduced lipid content, but having otherwise excellent mouth sense or organoleptic properties. During the preparation of commercially baked cookies, a typical fat constituent is butter or vegetable shortening, or mixtures thereof; and so as to utilize a lower fat or lipid content, particularly when butter is employed as a typical fat constituent, it is contemplated that so-called low fat butter may be employed. However, because of the requirement of the present invention that the fat constituent shall be mixed together with an organically derived phospholipid prior to their introduction to the sugar constituent, it may be advisable in some instances to employ a spreadable butter which includes an organically derived phospholipid in its formulation. Such a spreadable butter is one which is particularly disclosed in US patent publication No. 2011-0305813, by the inventor Miller, herein.

So as to better understand the commercial bakers' approach to calculating the constituents of a typical baked product, it may help to consider the origins of the baked product known typically as “pound cake”. The reason for that name comes from the fact that most commercial bakers, particularly those who are involved in the cookie and cake making industry, derived their recipes and mixed the constituents thereof on a unit weight basis. Thus, a traditional pound cake was made with 1 pound of flour, 1 pound of sugar, 1 pound of fat (usually, butter), and 1 pound of whole eggs. Accordingly, roughly 25% of the recipe is fat. But of greater concern and interest is the fact that most bakers, especially those who are involved in commercial bakery operations, base their formulations for their baked goods not only on a unit weight basis, but on the basis that the flour constituent of whatever formulation is being made is a reference quantity, usually 1 or 100, or a multiple thereof. That means that a batch of dough being prepared might have 1 or 100 units of flour—say, 100 kg—and the quantity of the remaining ingredients would be based on that reference quantity. Thus, a commercial batch of pound cake as described above might be made with 100 kg of flour, 100 kg of sugar, 100 kg of butter, and 100 kg of whole eggs; or perhaps even 300 kg of flour, 300 kg of sugar, 300 kg of butter, and 300 kg of whole eggs. With greater particularity to the present invention, a typical formulation for shortbread was a so-called 1:2:3 formulation, being a recital of the sugar, fat, and flour constituents, in that order. Thus, a commercial batch might comprise 100 kg of sugar, 200 kg of fat, and 300 kg of flour. From that formulation, it will be seen that the fat content of shortbread is 33%. A reduced fat shortbread might have a sugar:fat:flour mixture in the range of 4:3:8; from which it can be seen that the fat content of the reduced fat shortbread is 20%; and a batch of that reduced fat shortbread might comprise 40 kg of sugar, 30 kg of fat, and 80 kg of flour.

Another important advantage which is achieved by the present invention is that the dough system will be highly lubricated and have a lower surface tension. It will be recalled that the invention requires that an organically derived phospholipid shall be mixed with the fat constituent to be employed in the commercially baked cookie formulation before any other step is taken. Then, that mixture of fat constituent and organically derived phospholipid is added to the sugar constituent of the commercially baked cookie formulation and thoroughly mixed in a “creaming” operation as is well known to those skilled in the cookie art. It has been noted that by employing such ingredients in the order noted will result finally in a commercially baked cookie formulation which has a highly lubricated dough system having a lower surface tension as a consequence of the presence of the organically derived phospholipid, whereby the sugar constituent of the dough system is coated by the fat constituent/organically derived phospholipid mixture. Shelf life and texture are improved. A further important advantage which is derived by following the practice of the present invention is that the sugar constituent of the dough system will not caramelize when the dough system is subjected to elevated temperatures for baking.

A still further advantage of the present invention is one which affects the labeling of commercially baked cookies in such a manner that the commercially baked cookies will enjoy much higher acceptance in the market. This is because the commercially baked cookies may effectively enjoy a “clean label”; being a label which lists all of the ingredients of the commercially baked cookies, but where that list does not include chemicals such as emulsifiers or shelf life extenders. Moreover, labelling requirements typically require that the constituents or ingredients of the product shall be listed in descending order, by weight. That means that, in keeping with the present invention and as will be seen hereafter, the position of fat in the list of ingredients can move down on the level, giving rise therefore to greater acceptance in the market by persons who are particularly concerned with the fat, carbohydrate, and caloric values of the food products which they will consume.

As noted, an organically derived phospholipid is a key constituent of the finished product, albeit in small quantities. It has been remarked that the phospholipid serves two very important purposes: the first purpose being as an emulsifier or emulgent; and the second purpose being as a surfactant to reduce the surface tension of the fat ingredient in the commercially baked cookies, and thereby so as to better lubricate the dough system and to coat the sugar constituent thereof so as to protect it against air ingress and so as to preclude carmelization of the sugar constituent during baking.

A purpose of any emulsifier as employed, for instance, in the preparation of commercially baked cookies, is to stabilize the emulsion which comprises the fat constituent together with the organically derived phospholipid, by increasing the kinetic stability thereof. In the food industry, typical emulsifiers include egg yolk (of which the principal emulsifying agent is lecithin), or an emulsifier which is derived from soy beans. Emulsions are a type of solution in which surface tension plays a role. For example, tiny fragments of oil suspended in pure water will spontaneously assemble themselves into much larger masses of oil. However, the presence of a phospholipid as a surfactant will decrease the surface tension of the tiny fragments of oil, and therefore the stability of those minute droplets of oil is maintained.

A typical cookie compatible phospholipid which may be employed in keeping with the present invention is lecithin, which is a generic term that designates any group of yellow-brownish fatty substances which may occur in animal and plant tissues, and in egg yolk. The general composition of egg yolk comprises phosphoric acid, choline, fatty acids, glycerol, glycolipids, and triglycerides, together with phospholipids such as phosphatidylcoline (lecithin), phosphatidylethanolamine, and phosphatiedylinositol. Of course, it is lecithin which is the phospholipid of choice; at least in part because lecithin is easily and inexpensively obtained.

However, broadly stated, the organically derived phospholipid may be selected from the group consisting of phosphatydylinositol, cephalin, lecithin, phosphatydyl serine, or cardiolipin.

On the other hand, as already noted, monodiglycerides are not indicated nor are they acceptable, even though monodiglycerides are commonly used as emulsifiers. This is because they do not possess the additional characteristic of being a surfactant which is able to reduce surface tension. In any event, they are not organically derived.

It will also be noted that lecithin may be chemically or mechanically extracted from readily available sources such as soy beans. In all events, lecithin has a low solubility in water; and as noted, its principal purpose in the present invention is as a surfactant so as to lower surface tension. This is usually classified as being amphipathic; in other words, a substance which exhibits both hydrophilic and lipophilic properties.

A principal purpose of the present invention is to provide a means for reducing the fat constituent in commercially baked cookies by employing an organically derived phospholipid which is mixed, in the first instance, with the fat constituent of the commercially baked cookies; and which is thereafter thoroughly mixed with the sugar constituent of the commercially baked cookies prior to the preparation of the dough system by the addition of any further cookie dough compatible ingredients including flour, eggs, and other cookie compatible ingredients.

### SUMMARY OF THE INVENTION

In accordance with one aspect of the present invention, there is provided a means for the manufacture of flour-based cookies having any standard commercial cookie formulation which includes the presence of flour, sugar, fat, and any other cookie ingredients as required for a specific commercial cookie formulation, where the resulting commercially baked cookies have reduced lipid content.

In keeping with the present invention, the fat constituent of the commercial cookie formulation comprises a cookie-compatible lipid which has been combined with 0.2% to 7.0% of an organically derived phospholipid, based on the weight of fat solids of the cookie-compatible lipid.

Moreover, the present invention provides that the fat constituent is thoroughly mixed with the sugar constituent of the commercial cookie formulation prior to the mixture of the fat constituent and the sugar constituent being added to all other cookie ingredients of any specific commercial cookie formulation.

Preferably, the fat constituent of the commercial cookie formulation comprises a cookie-compatible lipid which has been combined with 0.3 to 6.0%, and more preferably, 0.4% to 2.5% of an organically derived phospholipid, based on the weight of fat solids of the cookie-compatible lipid.

The organically derived phospholipid may be chosen from the group consisting of an egg yolk derivative, a vegetable oil derivative, and the like.

The organically derived phospholipid may be selected from the group consisting of phosphatydyl inositol, cephalin, lecithin, phosphatydyl serine, or cardiolipin.

More particularly, however, the organically derived phospholipid may be a derivative of soy bean oil or sunflower oil; or it may be an egg yolk derivative.

In general, the organically derived phospholipid is preferably lecithin.

As is known in the commercial baking industry, the flour-based commercial cookies may have a fat constituent which is preferably chosen from the group consisting of butter, vegetable shortening, olive oil, coconut oil, corn oil, cottonseed oil, palm oil, peanut oil, rapeseed oil, canola oil, safflower oil, sesame oil, soybean oil, sunflower oil, nut or seed oils including almond oil, cashew oil, pine nut oil, hazelnut oil, and oils from melon and gourd seeds including pumpkin and watermelon seed oil, and mixtures and combinations thereof.

Moreover, as is also known in the commercial baking industry, the fat constituent or other cookie ingredients may have a water constituent therein, and that water constituent is substantially driven off from the commercial cookies as they are baked at an elevated temperature.

In keeping with the present invention, the mixed dough consisting of all of the ingredients of any specific commercial cookie formulation is preferably prepared and maintained at a temperature of 18° C. to 24° C. prior to baking.

The present invention allows that, for example, the other cookie ingredients are preferably chosen from the group consisting of whole eggs, reconstituted powdered eggs, vanilla extract, vanillin, soda, salt, cinnamon, rolled oats, bran, raisins, fruit pieces, dried fruit pieces, fruit peel, figs, raisin paste, chocolate chips, butterscotch chips, nuts, brandy, liquors, liqueurs, natural and artificial flavourings, natural and artificial colors, lemon juice, vinegar, milk, cookie compatible shelf life extenders, cookie compatible preservatives, and mixtures and combinations thereof.

A typical, preferred ratio of the sugar constituent, the fat constituent, and the flour constituent, by weight, is approximately 1:2:3, whereby the fat constituent comprises about 30% to 35% of the weight of the commercial cookies.

However, in a reduced fat commercially baked cookie, the ratio of the sugar constituent, the fat constituent, and the flour constituent, by weight, can be approximately 4:3:8, whereby the fat constituent comprises 15% to 25% of the weight of the commercial cookies.

As such, in further aspects, the present invention is also directed to the resultant cookies, per se, and the present invention is also directed to a method of manufacture of the cookies of the present invention, as described herein.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

As previously indicated, the purpose of the present invention is to provide means whereby commercially baked cookies can be brought to the market having reduced lipid content. This is accomplished primarily by reducing the amount of the fat constituent which is included in the commercially baked cookie formulation. However, it is important that the reduced fat constituent shall lubricate the dough system which will be baked into commercially baked cookies, and in keeping with the present invention that goal is accomplished by the provision of 0.2% to 7%, based on the weight of the fat content of the fat constituent, of an organically derived phospholipid which is mixed with the fat constituent prior to the fat constituent being mixed with the sugar constituent. That mixing is accomplished during the creaming step which occurs during cookie preparation; and the creaming step is that which comprises the mixing of the fat constituent with the sugar constituent of the commercially baked cookie formulation. Moreover, the creaming step must take place prior to the addition of any further cookie ingredients as called for by the commercially baked cookie formulation to the cookie dough being formed.

As noted, the organically derived phospholipid is typically one which is preferably derived from egg yolks or from soy beans or sunflower seeds; and in particular, the preferred organically derived phospholipid is lecithin.

In practice, one efficient way of attaining an appropriate fat constituent/organically derived phospholipid mixture is to obtain lecithinated butter, vegetable shortening, or other appropriate vegetable oils which are provided to the commercial bakery with the required amount of lecithin already added to the fat.

In any event, the next step to take place during the manufacture of commercially baked cookies, after obtaining the appropriate fat constituent/organically derived phospholipid mixture and placing it in a suitable vessel for further mixing, is the addition of the sugar constituent for the creaming step. The sugar constituent typically comprises mixtures of brown sugar and granulated sugar, but any suitable sugar may be employed in the reparation of commercially baked cookies as is well known to those skilled in the commercial cookie arts. After the creaming step, the flour and other ingredients such as whole eggs or reconstituted powdered eggs are added to form the dough system which will subsequently be baked at an elevated temperature in keeping with standard commercial cookie baking procedures.

It is important to state that the phospholipid which is employed in keeping with the present invention, in an amount of 0.2% to 7% based on the weight of the fat content of the fat constituent, is organically derived. Without limiting the derivation of such phospholipid, it is stated that a preferred phospholipid is lecithin, which may be derived from egg yolks, or from soy beans or sunflower seeds. However, it has been noted that the organically derived phospholipid may be selected from the group consisting of phosphatydyl inositol, cephalin, lecithin, phosphatydyl serine, or cardiolipin.

Moreover, while butter or vegetable shortening are the preferred fat constituents, it has been noted that the fat constituent which may be chosen from the group consisting of butter, vegetable shortening, olive oil, coconut oil, corn oil, cottonseed oil, palm oil, peanut oil, rapeseed oil, canola oil, safflower oil, sesame oil, soybean oil, sunflower oil, nut or seed oils including almond oil, cashew oil, pine nut oil, hazelnut oil, and oils from melon and gourd seeds including pumpkin and watermelon seed oil, and mixtures and combinations thereof.

Also, as noted, any of the fat constituents that may be employed may also have a water content, but the calculated amount of the organically derived phospholipid which is employed is based on the weight only of the fat content of that fat constituent. In any event, substantially all of the water content is driven off from the commercial cookies as they are baked at an elevated temperature.

During the preparation of a dough system in keeping with the present invention, care should be taken that the specific commercial cookie formulation which is to be made is preferably prepared and maintained at a temperature of 18° C. to 24° C. prior to baking.

Needless to say, any flour-based commercial cookies in keeping with the present invention may comprise a huge variety of other cooking ingredients apart from the fat constituent, the sugar constituent, and the flour constituent. Such additional or other cooking ingredients may be such as whole eggs, reconstituted powdered eggs, vanilla extract, vanillin, soda, salt, cinnamon, rolled oats, bran, raisins, fruit pieces, dried fruit pieces, fruit peel, figs, raisin paste, chocolate chips, butterscotch chips, nuts, brandy, liquors, liqueurs, natural and artificial flavourings, natural and artificial colors, lemon juice, vinegar, milk, cookie compatible shelf life extenders, cookie compatible preservatives, and mixtures and combinations thereof.

Without resorting to a specifically technical or theoretical discussion, and without limiting the scope and spirit of the present invention and the claims which define it, it is noted that the person skilled in the art of commercial cookie will understand and realize the advantages obtained by the incorporation of an organically derived phospholipid, in keeping with the present invention, into the fat constituent of any commercial cookie formulation prior to its being mixed with the sugar constituent of the commercial cookie formulation. However, the advantages of the use of an organically derived phospholipid in keeping with the present invention are twofold. First, the organically derived phospholipid acts as an emulsifier, whereby the tendency of the fat constituent at the molecular level to re-agglomerate is reduced. This will therefore result in a stable emulsion. Moreover, the presence of the organically derived phospholipid reduces the surface tension within the dough system, thereby providing for more efficient lubrication of the dough system, whereby the fat system is more universally spread or mixed into the dough system. Still further, by coating discrete particles of the sugar constituent of the commercially baked cookie formulation, carmelization of the sugar is effectively precluded during the process of the cookies.

Accordingly, in keeping with the present invention, the oil system having a lower surface tension within it, and therefore a more efficient and higher lubrication factor, is obtained with a lower quantity of fat constituent being employed, providing that the fat constituent has an organically derived phospholipid mixed therewith.

It has also been noted, however, that employment of a monodiglycerides as a replacement for the organically derived phospholipid is precluded because even though monodiglycerides will function as an emulsifier, they will not function as a suitable surfactant.

It will be understood, particularly by those who are skilled in the art of commercial cookie baking, that it is important to control the pH of the dough system. As is well known, control of the dough system at an appropriate pH may be accomplished by the addition of an appropriate but small amount of lemon juice or vinegar to the commercially baked cookie formulation. Is also been noted that maintenance of the dough system at a temperature of 18° C. to 24° C. is preferred from the point of view that dwell time of the dough in the ovens, and therefore consistency of baked product from batch to batch, is more easily obtained.

The hardness of the fat system may vary, depending on the fat constituent or mixture of constituents that are employed. However, lecithination of the fat system may cause the fat to appear to be softer, but it will be understood that the Solid Fat Index (SFI) of the fat system will not change.

### EXAMPLES

### Example 1A

The following is a formula for a typical generic oatmeal cookie, such as that which may be obtained anywhere in the market:

| | | |
|---|---|---|
| Rolled Oats | 138 | kg |
| Unbleached Flour | 100 | kg |
| Brown Sugar | 90 | kg |
| Butter | 60 | kg |
| Granulated Sugar | 60 | kg |
| Raisin Paste | 60 | kg |
| Canola or Soya Oil (pre-crystallized) | 30 | kg |
| Whole Eggs | 30 | kg |
| Lemon Juice (to control pH) | 3 | kg |
| Other Ingredients* | 8.2 | kg |
| | 581.2 | kg |

*vanilla extract, sodium bicarbonate, salt, cinnamon

In this example, it is noted that the fat constituent comprises butter (60 kg) and canola or soya oil (30 kg). However, given that the butter comprises 80% butterfat and 20% water, the actual fat content is 48 kg butterfat together with 30 kg of canola or soya oil. In other words, the actual fat content based on the total weight of the batch is 78/581.2%, or 13.42%. As noted below, this figure becomes important in labelling as it must be stated in the recital of Nutrition Facts, as required.

### Example 1B

The following is a formula for another typical oatmeal cookie which has been manufactured in keeping with the present invention:

| | | |
|---|---|---|
| Rolled Oats | 138 | kg |
| Unbleached Flour | 100 | kg |
| Brown Sugar | 102.75 | kg |
| Butter | 45 | kg |
| Granulated Sugar | 68.25 | kg |
| Raisin Paste | 60 | kg |
| Canola or Soya Oil (pre-crystallized) | 22.5 | kg |
| Whole Eggs | 30 | kg |
| Lemon Juice (to control pH) | 3 | kg |
| Lecithin | 1.5 | kg |
| Other Ingredients* | 10.2 | kg |
| | 581.2 | kg |

*vanilla extract, sodium bicarbonate, salt, cinnamon

Cookies which were baked according to the formulations of Examples 1A and 1B had essentially the same appearance. Moreover, the organoleptic properties (taste, crispiness, sweetness) of the two different batches of cookies were essentially the same in both instances. That is to say, in a blind test there were no discernible differences noted between the two batches of cookies.

A typical label which might be placed on a package of cookies in keeping with Example 1A might read as follows: “rolled oats, unbleached flour, brown sugar, butter, granulated sugar, raisin paste, canola or soya oil, whole eggs, lemon juice, vanilla extract, sodium bicarbonate, salt, cinnamon”. However, the Nutrition Facts list would be required to state that the fat content is 13.42%, as noted above.

On the other hand, a typical label which might be placed on a package of cookies in keeping with Example 1B might read as follows: “rolled oats, brown sugar, unbleached flour, granulated sugar, raisin paste, butter, whole eggs, canola or soya oil, vanilla extract, sodium bicarbonate, lecithin, lemon juice, salt, cinnamon”; and the Nutrition Facts list would be required only to state that the fat content is 10.06%. This shows that there has been a reduction of the fat content per se in the order of 25%. Moreover, it will be noted that the position of the butter content in the list of ingredients has dropped from the fourth position to the sixth position; and that the position of the canola or soya oil content in the list of ingredients has dropped from the seventh position to the eighth position.

It will, of course, be understood that a typical skilled baker in the commercial cookie arts would look to the above formulations for purposes of preparing a batch of cookies and would pay regard to the formulation to a unit weight basis. Thus, having regard to Examples 1A and 1B, respectively, 60 kg of butter and 30 kg of pre-crystallized canola or soya oil in the case of Example 1A, or 45 kg of butter and 22.5 kg of pre-crystallized canola or soya oil in the case of Example 1B, would be chosen. Moreover, in keeping with the present invention, when the baker follows the formulation of Example 1B, 1.5 kg of lecithin would have been added to the butter and canola or soya oil constituent in the first instance (or the already prepared mixture would have been obtained from the supplier), and that mixture of lecithin together with butter and oil would be creamed together with the brown sugar and granulated sugar constituents before being added to the flour and other constituents which comprise the dough system.

The batch sizes in each of Examples 1A and 1B remain the same, at 581.2 kg. In order to do so, the sugar content (both brown sugar and granulated sugar) has been slightly increased. This is typically not a matter of concern, because the sugar content in any event is sucrose, and does not comprise converted sugars such as fructose or glucose. However, it is possible that the market may look unkindly on cookies having any sort of increased sucrose content. Therefore, a further formulation for oatmeal cookies which reduces the fat content of the cookies in the same manner as already stated in Example 1B, and which also maintains the sugar content to be the same as set forth in Example 1A, follows.

### Example 1C

| | | |
|---|---|---|
| Rolled Oats | 138 | kg |
| Unbleached Flour | 100 | kg |
| Brown Sugar | 90 | kg |
| Butter | 45 | kg |
| Granulated Sugar | 60 | kg |
| Raisin Paste | 60 | kg |
| Canola or Soya Oil (pre-crystallized) | 22.5 | kg |
| Whole Eggs | 30 | kg |
| Lemon Juice (to control pH) | 3 | kg |
| Lecithin | 1.5 | kg |
| Other Ingredients* | 10.2 | kg |
| | 560.2 | kg |

*vanilla extract, sodium bicarbonate, salt, cinnamon

In this example, it will be seen that the fat content remains the same as in Example 1B, whereas the sugar content remains the same as in Example 1A. Moreover, the addition of lecithin in each of Examples 1A and 1B is 1.5 kg, or approximately 2.56% of the total fat content, allowing for the fact that 80% of the butter constituent is butterfat and the remaining 20% is water, by weight.

It follows that significant savings in the cost preparation of cookies in keeping with Examples 1A, 1B, and 1C, will be realized. Specifically, the reduction in the quantity of the most expensive constituents of the cookie formulation, being the butter and canola or soya oil constituents, in the order of 25%, means 25% lower cash outlay in the purchase of those ingredients. Those skilled in the art of commercial cookie baking, in particular, will recognize that the costs of the other ingredients such as flour, rolled oats, sugar, and whole eggs, on a per unit weight basis, may be considerably lower than the costs of butter and canola or soya oil on a unit weight basis.

### Example 2A

In this example, and Example 2B which follows, a representative commercial shortbread formulation is provided, along with a formulation for an essentially similar or identical shortbread in terms of flavour and organoleptic properties, but comprising lecithin as an ingredient and having a 25% lower fat content. It will be noted that these formulations follow the tradition with respect to shortbread cookies that they shall be manufactured in keeping with the Scottish tradition. In other words, the fat constituent is butter; of which 80% is butterfat, as previously noted.

| | | |
|---|---|---|
| Unbleached Flour | 100.0 | kg |
| Butter | 41.1 | kg |
| Granulated Sugar | 20.5 | kg |
| Icing Sugar | 15.4 | kg |
| Hot Water | 5.1 | kg |
| Salt | 1.3 | kg |
| Whey Powder | 0.8 | kg |
| Whole Eggs | 1.3 | kg |
| Sodium Bicarbonate | 0.2 | kg |
| Ammonium Bicarbonate | 0.1 | kg |
| | 185.7 | kg |

In this example, it is noted that the fat constituent comprises 41.1 kg of butter. In other words, the butter content is 41.1 kg of a 185.7 kg batch, or approximately 22.11% of the batch weight.

### Example 2B

Now, an example is given of an essentially identical shortbread, insofar as its appearance and organoleptic properties are concerned, but which comprises lecithin as a very important ingredient, and which has a fat content that has been reduced in the order of 25%.

| | | |
|---|---|---|
| Unbleached Flour | 100.0 | kg |
| Butter | 30.8 | kg |
| Granulated Sugar | 20.5 | kg |
| Icing Sugar | 15.4 | kg |
| Hot Water | 5.1 | kg |
| Salt | 1.3 | kg |
| Whey Powder | 0.8 | kg |
| Whole Eggs | 1.3 | kg |
| Sodium Bicarbonate | 0.2 | kg |
| Ammonium Bicarbonate | 0.1 | kg |
| Lecithin | 0.75 | kg |
| | 176.2 | kg |

Here, it is noted that the reduction of fat content between the Example 2A and Example 2B, is once again in the order of 25% in the formulation of Example 2B when compared with the fat content of Example 2A. The order in which the constituents are listed on a list of ingredients would remain essentially the same, with the exception of the addition of lecithin in the list of ingredients of Example 2B. However, because the appearance and organoleptic properties remain essentially the same, cookies made in keeping with the formulation of Example 2B can be marketed as having 25% less fat than ordinary shortbread cookies.

### Example 3A

An example is now given of a rotary moulded basecake. This is the kind of cookie, as is well known to those skilled in the commercial cookie bakery arts, that finds itself in a sandwich-type cookie usually having a cream filling between two such cookies. Rotary moulded basecake cookies may, themselves, be quite bland in flavour because the flavour experience of the consumer is intended to come from the cream filling. As will be seen hereafter, once again significant reductions of fat content can be achieved by the addition of lecithin or other organically derived phospholipid to the fat constituent of the cookie formulation.

| | | |
|---|---|---|
| Flour | 100.0 | kg |
| Icing Sugar | 25.0 | kg |
| Canola or Soya Oil (pre-crystallized) | 36.3 | kg |
| Hot Water | 5.0 | kg |
| Whey Powder | 2.0 | kg |
| Whole Eggs | 1.0 | kg |
| Ammonium Bicarbonate | 0.4 | kg |
| Salt | 0.3 | kg |
| Sodium Bicarbonate | 0.3 | kg |
| | 170.2 | kg |

In this example, it is seen that there is no butter constituent, and that canola or soya oil constituents are listed in the third position, and comprise approximately 21.33% of the total weight of the batch.

### Example 3B

This example shows the preparation of a rotary moulded basecake which is prepared in keeping with the present invention. That is to say, lecithin is employed as an important constituent; and as before, in the preparation of the dough system for the rotary basecakes, the lecithin is added to the canola or soya oil constituent in the first instance, before any other step is taken. The canola or soya oil constituent is then creamed with the icing sugar constituent in the next step, before the dough system is assembled in keeping with the following formulation.

| | | |
|---|---|---|
| Flour | 100.0 | kg |
| Icing Sugar | 25.0 | kg |
| Canola or Soya Oil (pre-crystallized) | 27.2 | kg |
| Hot Water | 5.0 | kg |
| Whey Powder | 2.0 | kg |
| Whole Eggs | 1.0 | kg |
| Ammonium Bicarbonate | 0.4 | kg |
| Salt | 0.3 | kg |
| Sodium Bicarbonate | 0.3 | kg |
| Lecithin | 1.4 | kg |
| | 162.5 | kg |

Having regard now to Example 3A and Example 3B, it will be noted once again that the fat constituent reduction between the two examples is in the order of 25%. In these examples, the position of the canola or soya oil constituent in a list of ingredients will remain in the second position, but the Nutrition Facts list will show that the combined fat constituent comprises only 16.75% in the case of Example 3B; whereas the Nutrition Facts list for cookies in keeping with Example 3A will show a combined fat constituent of 21.33%—a reduction of the fat constituent per se in the order of slightly over 25%. The addition of lecithin amounts to about 5.14% by weight of the fat content of the canola or soya oil constituent.

The reader will note that in all of these examples, there has been some rounding, particularly in the percentage listings. However, such rounding as may have occurred is insignificant having regard to the totality of the specific formulations being shown. Moreover, please note that these examples are given only as examples, and are not intended in any way to be limiting as to the scope of the present invention, nor are they intended to represent any specific commercial formulation. Neither do the examples represent or suggest that they are the only formulations for the types of cookies being discussed therein. However, the examples do represent and suggest that very significant advantages are achieved in keeping with the present invention by the addition of an organically derived phospholipid such as lecithin.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially all is intended to mean all, or nearly all, and/or exhibiting characteristics of a totality.

1. The manufacture of flour-based cookies having any standard commercial cookie formulation which includes the presence of flour, sugar, fat, and any other cookie ingredients as required for a specific commercial cookie formulation;
wherein the fat constituent of said commercial cookie formulation comprises a cookie-compatible lipid which has been combined with 0.2% to 7.0% of an organically derived phospholipid, based on the weight of fat solids of said cookie-compatible lipid; and
wherein said fat constituent is thoroughly mixed with said sugar constituent of said commercial cookie formulation prior to the mixture of said fat constituent and said sugar constituent being added to all other cookie ingredients of any specific commercial cookie formulation.

2. The flour-based commercial cookies of claim 1, wherein the fat constituent of said commercial cookie formulation comprises a cookie-compatible lipid which has been combined with 0.4% to 2.5% of an organically derived phospholipid, based on the weight of fat solids of said cookie-compatible lipid

3. The flour-based commercial cookies of claim 1, wherein said organically derived phospholipid is chosen from the group consisting of an egg yolk derivative and a vegetable oil derivative.

4. The flour-based commercial cookies as claimed in claim 1, wherein said phospholipid is selected from the group consisting of phosphatydyl inositol, cephalin, lecithin, phosphatydyl serine, or cardiolipin.

5. The flour-based commercial cookies as claimed in claim 3, wherein said phospholipid is a derivative of soy bean oil.

6. The flour-based commercial cookies as claimed in claim 3, wherein said phospholipid is an egg yolk derivative.

7. The flour-based commercial cookies as claimed in claim 1, wherein said phospholipid is lecithin.

8. The flour-based commercial cookies as claimed in claim 1, wherein said fat constituent is chosen from the group consisting of butter, vegetable shortening, olive oil, coconut oil, corn oil, cottonseed oil, palm oil, peanut oil, rapeseed oil, canola oil, safflower oil, sesame oil, soybean oil, sunflower oil, nut or seed oils including almond oil, cashew oil, pine nut oil, hazelnut oil, and oils from melon and gourd seeds including pumpkin and watermelon seed oil, and mixtures and combinations thereof.

9. The flour-based commercial cookies as claimed in claim 1, wherein any of said fat constituent or other cookie ingredients may have a water constituent therein, and wherein said water constituent is substantially driven off from the commercial cookies as they are baked at an elevated temperature.

10. The flour-based commercial cookies as claimed in claim 1, wherein the mixed dough consisting of all of the ingredients of any specific commercial cookie formulation is prepared and maintained at a temperature of 18° C. to 24° C. prior to baking.

11. The flour-based commercial cookies as claimed in claim 1, wherein said other cookie ingredients may be chosen from the group consisting of whole eggs, reconstituted powdered eggs, vanilla extract, vanillin, soda, salt, cinnamon, rolled oats, bran, raisins, fruit pieces, dried fruit pieces, fruit peel, figs, raisin paste, chocolate chips, butterscotch chips, nuts, brandy, liquors, liqueurs, natural and artificial flavourings, natural and artificial colors, lemon juice, vinegar, milk, cookie compatible shelf life extenders, cookie compatible preservatives, and mixtures and combinations thereof.

12. The flour-based commercial cookies as claimed in claim 1, wherein the ratio of said sugar constituent, said fat constituent, and said flour constituent, by weight, is 1:2:3, whereby said fat constituent comprises 33.3% of the weight of said commercial cookies.

13. The flour-based commercial cookies as claimed in claim 1, wherein the ratio of said sugar constituent, said fat constituent, and said flour constituent, by weight, is 4:3:8, whereby said fat constituent comprises 20% of the weight of said commercial cookies.

14. A method for the manufacture of flour-based cookies which cookies have any standard commercial cookie formulation including the presence of flour, sugar, fat, and any other cookie ingredients as required for a specific commercial cookie formulation, comprising:
combining said fat constituent of said commercial cookie formulation, which fat constituent comprises a cookie-compatible lipid, with 0.2% to 7.0% of an organically derived phospholipid, based on the weight of fat solids of said cookie-compatible lipid; and
mixing said fat constituent thoroughly with said sugar constituent of said commercial cookie formulation prior to the mixture of said fat constituent and said sugar constituent being added to all other cookie ingredients of any specific commercial cookie formulation.
